(19) United States
(12) Patent Application Publication
(10) Pub. No.: US 2023/0234608 A1
(43) Pub. Date: Jul. 27, 2023

(54) PATH GENERATION APPARATUS AND PATH GENERATION METHOD

(71) Applicant: Honda Motor Co., Ltd., Tokya (JP)

(72) Inventor: Kazuki Tomioka, Tokyo (JP)

(21) Appl. No.: 18/098,691

(22) Filed: Jan. 18, 2023

(30) Foreign Application Priority Data
Jan. 24, 2022 (JP) 2022-008736

(51) Int. Cl. B60W 60/00; B60W 40/10

(52) U.S. Cl. CPC B60W 60/001; B60W 40/10; B60W 2420/42

(57) ABSTRACT

Path generation apparatus configured to generate target path of own vehicle, includes: sensor configured to detect objects in forward area of own vehicle; and electronic control unit including processor and memory coupled to processor. Electronic control unit is configured to perform: recognizing adjacent vehicle traveling in adjacent lane adjacent to travel lane in which own vehicle travels from among objects detected by sensor; generating reference path of own vehicle in travel lane; setting safe area from side end portion of adjacent vehicle toward travel lane; and generating target path of own vehicle based on reference path. Generating target path includes: setting reference path to target path in predetermined section on forward side of own vehicle; and modifying reference path to ensure safe area between own vehicle and adjacent vehicle on forward side of predetermined section to generate target path.

### CROSS-REFERENCE TO RELATED APPLICATION

This application is based upon and claims the benefit of priority from Japanese Patent Application No. 2022-008736 filed on Jan. 24, 2022, the content of which is incorporated herein by reference.

### BACKGROUND OF THE INVENTION

### Field of the Invention

This invention relates to a path generation apparatus and a path generation method configured to generate a target path of an own vehicle having an automatic driving function or a driving-assistance function.

### Description of the Related Art

As a device of this type, a driving-assistance device that sets a steering angle of an own vehicle, based on a recognized white line, is conventionally known (see, for example, JP2014-129021A). In the device described in JP2014-129021A, a forward gazing point at which the own vehicle is predicted to be present after a preset prediction time elapses is set, and when an overtaking vehicle is present in an adjacent lane behind the own vehicle, the front gazing point is offset in a direction away from the overtaking vehicle.

As vehicles each having an automatic driving function and a driving-assistance function become widely used, the safety and convenience of the entire traffic society are improved, and a sustainable transportation system is achievable. In addition, as the efficiency and smoothness of transportation are improved, CO₂ emission amounts are reduced, and loads on the environment can be reduced.

In a case where the target path is offset in the direction away from the overtaking vehicle as in the device described in JP2014-129021A, however, the travel path may suddenly change depending on the timing when the overtaking vehicle is recognized, and may give an occupant a sense of incongruity.

### SUMMARY OF THE INVENTION

An aspect of the present invention is a path generation apparatus configured to generate a target path of an own vehicle, including: a sensor configured to detect objects in a forward area of the own vehicle; and an electronic control unit including a processor and a memory coupled to the processor. The electronic control unit is configured to perform: recognizing an adjacent vehicle traveling in an adjacent lane adjacent to a travel lane in which the own vehicle travels from among the objects detected by the sensor; generating a reference path of the own vehicle in the travel lane; setting a safe area from a side end portion of the adjacent vehicle toward the travel lane; and generating the target path of the own vehicle based on the reference path. The generating the target path includes: setting the reference path to the target path in a predetermined section on a forward side of the own vehicle; and modifying the reference path to ensure the safe area between the own vehicle and the adjacent vehicle on a forward side of the predetermined section to generate the target path.

Another aspect of the present invention is a path generation method configured to generate a target path of an own vehicle, including: recognizing an adjacent vehicle traveling in an adjacent lane adjacent to a travel lane in which the own vehicle travels from among objects in a forward area of the own vehicle detected by a sensor; generating a reference path of the own vehicle in the travel lane; setting a safe area from a side end portion of the adjacent vehicle toward the travel lane; and generating the target path of the own vehicle based on the reference path. The generating the target path includes: setting the reference path to the target path in a predetermined section on a forward side of the own vehicle; and modifying the reference path to ensure the safe area between the own vehicle and the adjacent vehicle on a forward side of the predetermined section to generate the target path.

### BRIEF DESCRIPTION OF THE DRAWINGS

The objects, features, and advantages of the present invention will become clearer from the following description of embodiments in relation to the attached drawings, in which:

FIG. 1 is a diagram for describing a target path;

FIG. 2 is a diagram for describing change of the target path;

FIG. 3 is a block diagram schematically illustrating an example of a configuration of main components and a processing flow of a path generation apparatus according to an embodiment of the present invention;

FIG. 4A is a diagram for describing generation of a reference path and the target path by a reference path generation unit and a target path generation unit shown in FIG. 3;

FIG. 4B is a diagram illustrating a modification of FIG. 4A; and

FIG. 5 is a flowchart illustrating an example of a flow of path generation processing by the apparatus according to an embodiment of the present invention.

### DETAILED DESCRIPTION OF THE INVENTION

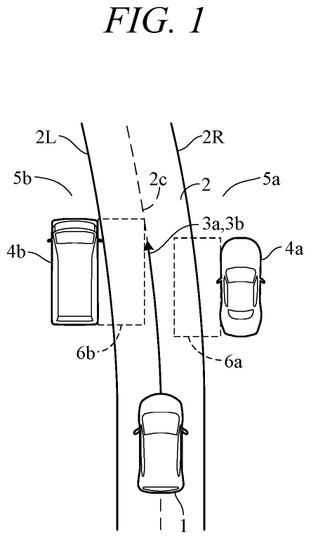

Hereinafter, embodiments of the present invention will be described with reference to FIGS. 1 to 5. A path generation apparatus according to an embodiment of the present invention is applied to a vehicle having a driving-assistance function of controlling a travel actuator to conduct driving assistance for a driver of the own vehicle or to automatically drive the own vehicle, and generates a target path (target travel path) of the own vehicle. The “driving assistance” in the present embodiment includes driving assistance for assisting driver's driving operations and automatic driving for automatically driving a vehicle without depending on the driver's driving operations, and corresponds to levels 1 to 4 of driving automation defined by SAE, and the “automatic driving” corresponds to the level 5 driving automation.

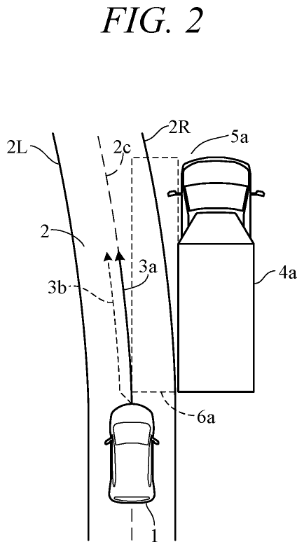

FIGS. 1 and 2 are each a diagram for describing a target path, and illustrate an example of a traveling scene in which an own vehicle 1 is traveling along a center line 2C of a travel lane 2. In this case, for example, a reference path 3a along the center line 2C of the travel lane 2 is generated, based on a recognition result of the travel lane 2 on a forward side of the vehicle by a camera or the like. Furthermore, the reference path 3a is modified as necessary, based on recognition results of adjacent vehicles 4a and 4b, which are respectively traveling in adjacent lanes 5a and 5b adjacent to the travel lane 2, in which the own vehicle 1 is traveling, and a final target path 3b is generated. More specifically, the target path 3b is generated by modifying the reference path 3a to respectively ensure predetermined safe areas 6a and 6b between the own vehicle 1 and the adjacent vehicles 4a and 4b. The reference path 3a and the target path 3b are generated and updated every unit time, based on a latest recognition result.

During driving assistance or automatic driving, the steering mechanism of the own vehicle 1 is controlled to travel along the target path 3b, and in addition, the driving mechanism and the braking mechanism are controlled to adjust the vehicle speed (travel speed of the own vehicle 1) in accordance with the distances to the adjacent vehicles 4a and 4b and to avoid a collision with the adjacent vehicles 4a and 4b. Therefore, even though the target path 3b is generated without consideration of the safe areas 6a and 6b, the safety is ensured. The safe areas 6a and 6b are considered to mitigate an uneasy feeling that an occupant may have, when the distances between the own vehicle 1 and the adjacent vehicles 4a and 4b are short.

As illustrated in FIG. 2, however, when the own vehicle 1 is overtaken by the adjacent vehicle 4a, such as a large-sized truck having a large vehicle width, traveling closely to the travel lane 2 in which the own vehicle 1 is traveling, the target path 3b is suddenly changed immediately after being overtaken, in some cases. This may make the occupant feel uneasy conversely. Specifically, in a case where it is determined that the safe area 6a is not ensured between the own vehicle 1 and the adjacent vehicle 4a, based on the latest recognition result immediately after being overtaken, the reference path 3a (the target path 3b immediately before) is modified to ensure the safe area 6a, and thus the target path 3b is changed suddenly. Therefore, in the present embodiment, the path generation apparatus is configured as follows so as to be capable of suppressing such a sudden change of the target path 3b.

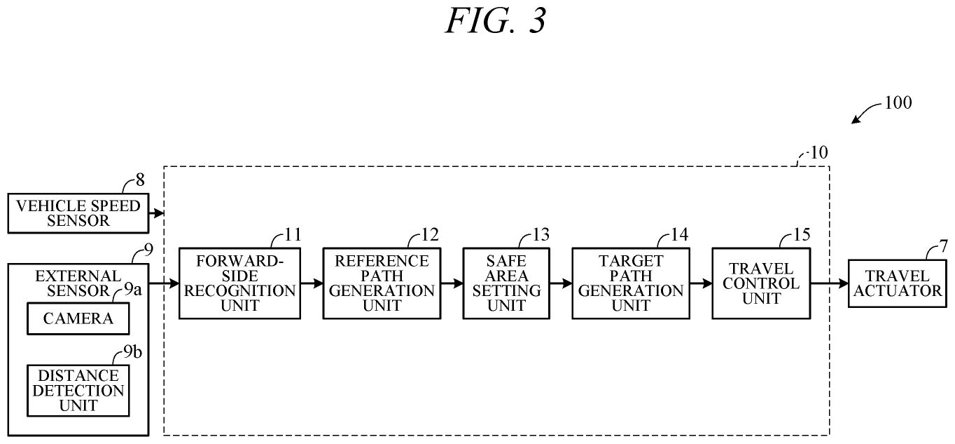

FIG. 3 is a block diagram schematically illustrating an example of a configuration of main components and a processing flow of the path generation apparatus (hereinafter, an apparatus) 100 according to an embodiment of the present invention. As illustrated in FIG. 3, the apparatus 100 mainly includes an electronic control unit (ECU) 10. The ECU 10 includes a computer including a (processor) such as a CPU, a storage unit (memory) such as a RAM and a ROM, an I/O interface, and other peripheral circuits. The ECU 10 is configured, for example, as a part of a plurality of ECU groups that are mounted on an own vehicle 1 and that control the operation of the own vehicle 1. The processing of FIG. 3 is started, for example, when the own vehicle 1 starts operating and the ECU 10 is activated, and is repeated at a predetermined cycle.

A travel actuator 7, a vehicle speed sensor 8, and an external sensor 9, which are mounted on the own vehicle 1, are connected with the ECU 10. The travel actuator 7 includes a driving mechanism such as an engine or a motor that drives the own vehicle 1, a braking mechanism such as a brake that applies the brakes of the own vehicle 1, and a steering mechanism such as a steering gear that steers the own vehicle 1. The vehicle speed sensor 8 includes, for example, a wheel speed sensor that detects a rotation speed of a wheel, and detects a vehicle speed V.

The external sensor 9 detects an external situation including a location of an object in a forward area of the own vehicle 1. The external sensor 9 includes an imaging element such as a CCD or a CMOS, and includes a camera 9a, which images a forward area of the own vehicle 1, and a distance detection unit 9b, which detects a distance from the own vehicle 1 to an object in the forward area. The distance detection unit 9b includes, for example, a millimeter wave radar that irradiates millimeter waves (radio waves) and measures a distance and a direction to an object by use of a period of time until the irradiated wave hits the object and then returns. The distance detection unit 9b may include a light detection and ranging (LiDAR) that irradiates laser light and measures a distance and a direction to an object by use of a period of time until the irradiated light hits the object and then returns.

The ECU 10 includes a forward-side recognition unit 11, a reference path generation unit 12, a safe area setting unit 13, a target path generation unit 14, and a travel control unit 15, as functional configurations of an arithmetic unit. Specifically, the arithmetic unit of the ECU 10 functions as the forward-side recognition unit 11, the reference path generation unit 12, the safe area setting unit 13, the target path generation unit 14, and the travel control unit 15.

The forward-side recognition unit 11 recognizes a location of a division line, a curbstone, a guardrail, or the like on a road on a forward side of the vehicle with the advancing direction of the own vehicle 1 as the center, based on a signal from the external sensor 9, and thus recognizes the travel lane 2, in which the own vehicle 1 is traveling, and adjacent lanes 5a and 5b, which are each adjacent to the travel lane 2. In addition, the adjacent vehicles 4a and 4b are recognized by recognizing positions of the contours of the adjacent vehicles 4a and 4b, which are respectively traveling in the adjacent lanes 5a and 5b.

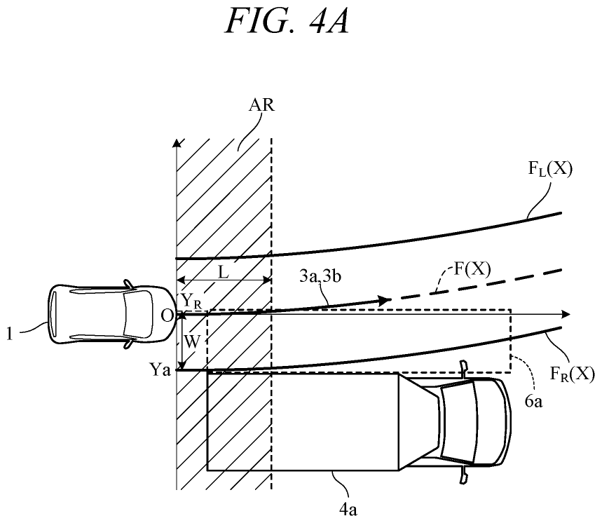

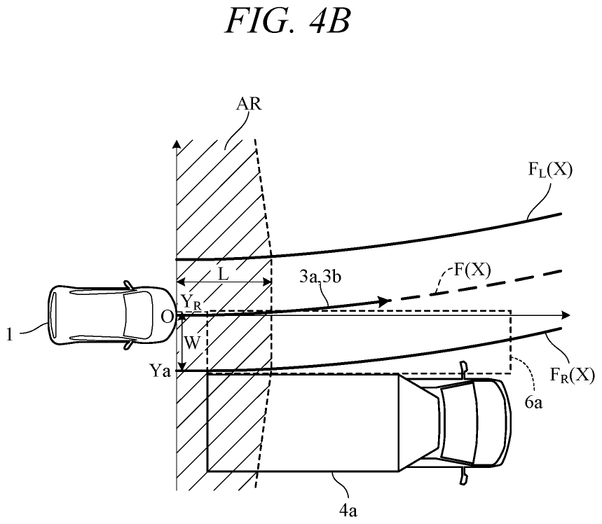

FIG. 4A is a diagram for describing generation of the reference path 3a and the target path 3b to be respectively generated by the reference path generation unit 12 and the target path generation unit 14. The reference path generation unit 12 generates the reference path 3a of the own vehicle 1 in the travel lane 2, based on a recognition result of the travel lane 2 by the forward-side recognition unit 11. A typical road shape is designed with a clothoid curve in which the curvature changes at a certain rate, and some sections of the clothoid curve corresponding to the road shape can be approximated by use of a higher-order function such as a cubic function.

The reference path generation unit 12 identifies an advancing direction of the own vehicle 1 with respect to the travel lane 2, based on the recognition result by the forward-side recognition unit 11, and derives a cubic function F(X) representing the center line 2C of the travel lane 2 with the current location point of the own vehicle 1 as an origin O and the identified advancing direction as x-axis. Specifically, the cubic functions F_{L}(X) and F_{R}(X) of following Expressions (i) and (ii), which respectively approximate the left and right division lines (or curbstones, guardrails, or the like) 2L and 2R that have been recognized by the forward-side recognition unit 11, are derived by use of a curve fitting method such as a least squares method.

F_{L}(X)=C_{3L}X³+C_{2L}X²+C_{1L}X+C_{0L} (i)

F_{R}(X)=C_{3R}X³+C_{2R}X²+C_{1R}+X C_{OR} (ii)

Next, a cubic function F(X) of a following Expression (iii) corresponding to the center line 2C of the travel lane 2 is derived, based on the cubic functions FL(X) and FR(X) respectively corresponding to the left and right division lines 2L and 2R, and the reference path 3a is generated along the center line 2C, which is represented by the cubic function F(X) that has been derived.

F(X)=C₃X³+C₂X²+C₁X+C₀ (iii)

C₃=(C_{3L}+C_{3R})/2, C₂=(C_{2L}+C_{2R})/2

C₁=(C_{1L}+C_{1R})/2, C₀=(C_{0L}+C_{0R})/2

The safe area setting unit 13 sets, as the safe area 6a, an area within a predetermined distance W from a lateral end of the adjacent vehicle 4a that has been recognized by the forward-side recognition unit 11 toward the reference path 3a of the own vehicle 1 in the travel lane 2. More specifically, as illustrated in FIG. 4A, the safe area 6a (Yₐ≤Y≤YR) is set by identifying a y-coordinate Yₐ of the lateral end of the adjacent vehicle 4a, based on the recognition result by the forward-side recognition unit 11, and identifying a y-coordinate Y_{R}(Y_{R}=Yₐ+W) of a lateral end of the safe area 6a.

The target path generation unit 14 sets the reference path 3a, which has been generated by the reference path generation unit 12 as it is, to the target path 3b of the own vehicle 1 without modifying the reference path 3a, in a recognition cut section AR (0≤X≤L) set on a forward side from the own vehicle 1 by a predetermined distance L. More specifically, even in a case where the safe area 6a is not ensured between the reference path 3a of the own vehicle 1 and the adjacent vehicle 4a (Y_{R}≥F(X)), as long as a location point where the safe area 6a is not ensured is present in the recognition cut section AR (0≤X≤L), the reference path 3a is set to the target path 3b without a modification. This enables suppression of an unnecessary sudden change of the target path 3b, even when the adjacent vehicle 4a, which is traveling closely to the travel lane 2 in which the own vehicle 1 is traveling, is recognized immediately after overtaking the own vehicle 1.

The predetermined distance L of the recognition cut section AR is set as a distance that the own vehicle 1 will reach after a predetermined time t₀ elapses (for example, approximately 0.9 seconds), based on the vehicle speed V that has been detected by the vehicle speed sensor 8 (L=Vt₀). The predetermined distance L of the recognition cut section AR may be set as a constant distance regardless of the vehicle speed V. The predetermined distance L of the recognition cut section AR may be set in accordance with a speed limit or the like of the road on which the vehicle is traveling.

FIG. 4B is a diagram illustrating a modification of the recognition cut section AR. The recognition cut section AR may be set as a substantially rectangular area in a plan view extending in a left-right direction on a forward side of the own vehicle 1 as illustrated in FIG. 4A, or may be set as a substantially trapezoidal area in a plan view extending in the left-right direction on the forward side of the own vehicle 1 as illustrated in FIG. 4B. In this case, for example, the predetermined distance L is set to be shorter, as separating from the travel lane 2.

As illustrated in FIG. 2, on a forward side of the recognition cut section AR (X>L), the target path generation unit 14 modifies the reference path 3a to ensure the safe area 6a between the own vehicle 1 and the adjacent vehicle 4a, and generates the target path 3b. More specifically, in a case where it is determined that the safe area 6a is not ensured between the reference path 3a of the own vehicle 1 and the adjacent vehicle 4a at a location point beyond the recognition cut section AR (Y_{R}≥F(X) and X>L), the reference path 3a is modified to ensure the safe area 6a, and the target path 3b is generated.

The travel control unit 15 controls the travel actuator 7 to conduct driving assistance for the driver of the own vehicle 1 or to automatically drive the own vehicle 1, based on the target path 3b that has been generated by the target path generation unit 14. This enables suppression of a sudden change of the target path 3b, and enables the own vehicle 1 to travel along the target path 3b that is stable.

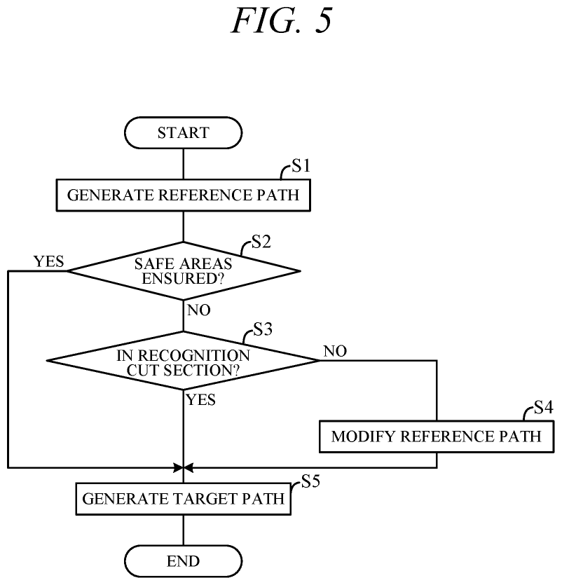

FIG. 5 is a flowchart illustrating a flow of path generation processing by the apparatus 100, and illustrates a flow of processing of a program executed by the arithmetic unit of the apparatus 100. The processing of FIG. 5 is started, for example, when the own vehicle 1 starts operating and the ECU 10 is activated, and is repeated at a predetermined cycle.

First, in S1 (S denotes a processing step), the travel lane 2 in which the own vehicle 1 is traveling and the adjacent vehicles 4a and 4b respectively traveling in the adjacent lanes 5a and 5b are recognized, based on signals from the external sensor 9, and the reference path 3a is generated and the safe areas 6a and 6b are also set, based on recognition results. Next, in S2, it is determined whether the safe areas 6a and 6b set in S2 are respectively ensured between the reference path 3a generated in S1 and the adjacent vehicles 4a and 4b. In a case where a negative determination is made in S2, the processing proceeds to S3, and in a case where a positive determination is made, the processing proceeds to S5.

In S3, it is determined whether a location point where the safe areas 6a and 6b are not ensured is present in the recognition cut section AR. In a case where a negative determination is made in S3, the processing proceeds to S4, and in a case where a positive determination is made, the processing proceeds to S5. In S4, the reference path 3a generated in S1 is modified so as to ensure the safe areas 6a and 6b set in S2 between the reference path 3a generated in S1 and the adjacent vehicles 4a and 4b. In S5, the reference path 3a generated in S1 is set as the target path 3b without modification.

The present embodiment is capable of achieving the following operations and effects.

(1) The apparatus 100 includes: the external sensor 9, which detects an object in a forward area of the own vehicle 1; the forward-side recognition unit 11, which recognizes adjacent vehicles 4a and 4b respectively traveling in adjacent lanes 5a and 5b adjacent to the travel lane 2 in which the own vehicle 1 is traveling, from objects that has been detected by the external sensor 9; the reference path generation unit 12, which generates a reference path 3a of the own vehicle 1 in the travel lane 2; the safe area setting unit 13, which sets safe areas 6a and 6b from side end portions of the adjacent vehicles 4a and 4b that have been recognized by the forward-side recognition unit 11 toward the travel lane 2; and the target path generation unit 14, which generates a target path 3b of the own vehicle 1, based on the reference path 3a that has been generated by the reference path generation unit 12 (FIG. 3).

The target path generation unit 14 sets the reference path 3a to the target path 3b in the recognition cut section AR on a forward side of the own vehicle 1, modifies the reference path 3a to ensure the safe areas 6a and 6b that have been set by the safe area setting unit 13 between the own vehicle 1 and the adjacent vehicles 4a and 4b that have been recognized by the forward-side recognition unit 11, on a forward side of the recognition cut section AR, and generates the target path 3b (FIG. 4A and FIG. 4B). This enables suppression of an unnecessary sudden change of the target path 3b, even when the adjacent vehicle 4a, which is traveling closely to the travel lane 2 in which the own vehicle 1 is traveling, is recognized immediately after overtaking the own vehicle 1.

(2) The recognition cut section AR is set to a predetermined area having a substantially rectangular shape or a substantially trapezoidal shape in a plan view extending in the left-right direction on the forward side of the own vehicle 1 (FIG. 4A and FIG. 4B). By providing the recognition cut section AR in the right-left direction in the area immediately on the forward side of the own vehicle 1, it is possible to reliably suppress an unnecessary sudden change of the target path 3b, even when the adjacent vehicles 4a and 4b are recognized immediately on the forward side of the own vehicle 1.

(3) The apparatus 100 further includes the travel control unit 15, which controls the travel actuator 7 to conduct driving assistance for the driver of the own vehicle 1 or to automatically drive the own vehicle 1 (FIG. 3). The travel control unit 15 controls the travel actuator 7, based on the target path 3b that has been generated by the target path generation unit 14. This enables suppression of a sudden change of the target path 3b, and enables the own vehicle 1 to travel along the target path 3b that is stable.

In the above embodiments, the description has been made in which the external sensor 9 including the camera 9a and the distance detection unit 9b such as a millimeter wave radar or a light detection and ranging (LiDAR) is illustrated. However, the detection unit that detects an object in a forward area of the own vehicle is not limited to such an example. For example, the distance from the own vehicle 1 to the object in the forward area may be detected, based on the image data of the forward area of the vehicle that has been imaged by the camera 9a. In this case, the external sensor 9 may be made up of only the camera 9a.

In the above embodiments, an example in which the reference path generation unit 12 generates the reference path 3a along the center line 2C of the travel lane 2 has been described. However, the reference path generation unit that generates the reference path of the own vehicle in the travel lane is not limited to such an example. For example, the reference path 3a, which is closer to the outside of the road than to the center line 2C, may be generated along the travel lane 2.

In the above embodiments, an example in which the apparatus 100 includes the travel control unit 15 has been described. However, the path generation apparatus is not limited to such an example. For example, a display control unit, which controls a display unit such as a head-up display for displaying the target path 3b that has been generated by the target path generation unit 14 to be superimposed on a road on a forward side of the vehicle, may be included.

The above embodiment can be combined as desired with one or more of the aforesaid modifications. The modifications can also be combined with one another.

According to the present invention, it becomes possible to suppress sudden change of the target path.

Above, while the present invention has been described with reference to the preferred embodiments thereof, it will be understood, by those skilled in the art, that various changes and modifications may be made thereto without departing from the scope of the appended claims.

Claims:

1. A path generation apparatus configured to generate a target path of an own vehicle, comprising:
a sensor configured to detect objects in a forward area of the own vehicle; and
an electronic control unit including a processor and a memory coupled to the processor, wherein
the electronic control unit is configured to perform:
recognizing an adjacent vehicle traveling in an adjacent lane adjacent to a travel lane in which the own vehicle travels from among the objects detected by the sensor;
generating a reference path of the own vehicle in the travel lane;
setting a safe area from a side end portion of the adjacent vehicle toward the travel lane; and
generating the target path of the own vehicle based on the reference path,
wherein
the generating the target path includes:
setting the reference path to the target path in a predetermined section on a forward side of the own vehicle; and
modifying the reference path to ensure the safe area between the own vehicle and the adjacent vehicle on a forward side of the predetermined section to generate the target path.

2. The path generation apparatus according to claim 1, wherein
the predetermined section is set to a predetermined area having a substantially rectangular shape or a substantially trapezoidal shape in a plan view extending in a left-right direction on a forward side of the own vehicle.

3. The path generation apparatus according to claim 1, wherein
the electronic control unit is further configured to perform:
controlling a travel actuator to conduct driving assistance for a driver of
the own vehicle or to automatically drive the own vehicle, wherein
the controlling includes controlling the travel actuator based on the target path.

4. The path generation apparatus according to claim 1, wherein
the sensor includes a camera.

5. The path generation apparatus according to claim 1, wherein
the predetermined section is set on a forward side from the own vehicle by a predetermined distance.

6. The path generation apparatus according to claim 5, wherein
the predetermined distance is calculated as a distance that the own vehicle will reach after a predetermined time period based on a travel speed of the own vehicle or a speed limit of the travel lane.

7. A path generation method configured to generate a target path of an own vehicle, comprising:
recognizing an adjacent vehicle traveling in an adjacent lane adjacent to a travel lane in which the own vehicle travels from among objects in a forward area of the own vehicle detected by a sensor;
generating a reference path of the own vehicle in the travel lane;
setting a safe area from a side end portion of the adjacent vehicle toward the travel lane; and
generating the target path of the own vehicle based on the reference path,
wherein
the generating the target path includes:
setting the reference path to the target path in a predetermined section on a forward side of the own vehicle; and
modifying the reference path to ensure the safe area between the own vehicle and the adjacent vehicle on a forward side of the predetermined section to generate the target path.

8. The path generation method according to claim 7, wherein
the predetermined section is set to a predetermined area having a substantially rectangular shape or a substantially trapezoidal shape in a plan view extending in a left-right direction on a forward side of the own vehicle.

9. The path generation method according to claim 7, further comprising:
controlling a travel actuator to conduct driving assistance for a driver of the own vehicle or to automatically drive the own vehicle, wherein
the controlling includes controlling the travel actuator based on the target path.

10. The path generation method according to claim 7, wherein
the sensor includes a camera.

11. The path generation method according to claim 7, wherein
the predetermined section is set on a forward side from the own vehicle by a predetermined distance.

12. The path generation method according to claim 11, wherein
the predetermined distance is calculated as a distance that the own vehicle will reach after a predetermined time period based on a travel speed of the own vehicle or a speed limit of the travel lane.
